(19) United States
(12) Patent Application Publication
(10) Pub. No.: US 2017/0186024 A1
(43) Pub. Date: Jun. 29, 2017

(54) NETWORK DEVICE, GENERATION METHOD, AND COMPUTER PROGRAM THAT IDENTIFY SIMILAR USERS BASED ON PHYSIOLOGICAL CHARACTERISTICS TO PREDICT EXPENSE TRENDS

(71) Applicant: YAHOO JAPAN CORPORATION, Tokyo (JP)

(72) Inventors: Tomohito TAKUSARI, Tokyo (JP); Yasuyoshi ABE, Tokyo (JP); Hiromoto ONE, Tokyo (JP); Takafumi KUROHARA, Tokyo (JP); Yosuke SHIRAISHI, Tokyo (JP)

(73) Assignee: YAHOO JAPAN CORPORATION, Tokyo (JP)

(21) Appl. No.: 15/251,430

(22) Filed: Aug. 30, 2016

(30) Foreign Application Priority Data
Dec. 25, 2015 (JP) 2015-255087

(51) Int. Cl. G06Q 30/02

(52) U.S. Cl. CPC G06Q 30/0204; G06Q 30/0201

(57) ABSTRACT

Network devices, methods, and programs identify similar subjects based on physiological characteristics to predict income and expense trends. The devices, methods, and programs receive a user profile from a user terminal via a network interface, the user profile identifying physiological characteristics of the user and an age of the user, and compare the physiological characteristics of the received user profile with physiological characteristics in stored subject profiles to identify a subject having similar physiological characteristics to the user. The devices, methods, and programs analyze expense information that is associated with the identified subject to determine a trend of the expense of the identified subject, and generate a proposal including a predicted future expense trend for the user based on the determined trend and the user's age. The devices, methods, and programs then transmit the generated proposal to the user terminal via the network interface.

### CROSS-REFERENCE TO RELATED APPLICATION

The present application claims priority to and incorporates by reference the entire contents of Japanese Patent Application No. 2015-255087, filed in Japan on Dec. 25, 2015.

### BACKGROUND

1. Related Technical Fields

Related technical fields include network devices, methods, and programs that identify similar users based on physiological characteristics to predict expense trends.

2. Related Art

Services are present that analyze information about users in relation to the user's asset management so as to introduce asset management methods suitable for the users.

As an example of techniques relating to such services, a technique about a system is known that can efficiently perform simulation to support making a financial plan using the Internet. A conventional technique is described in Japanese Patent Application Laid-open No. 2002-41808, for example.

### SUMMARY

It is, however, difficult for the conventional technique to provide a user with appropriate information about the user's future plan. For example, the conventional technique only provides the user with a result of the simulation about the asset at various stages in the user's life. The user, thus, obtains only a plan for managing income and expense under a specific situation. As a result, the user does not always obtain appropriate information about asset formation based on a comprehensive viewpoint such as whether a current tendency in expense is appropriate in the user's future life plan, for example.

Exemplary embodiments of the broad inventive principles described herein at least partially solve the problems in the conventional technology.

Network devices, methods, and programs according to exemplary embodiments access a memory that stores expense information for each of a plurality of subjects, the expense information for each of the plurality of subjects being associated with a stored subject profile that identifies physiological characteristics of a corresponding one of the subjects. The devices, methods, and programs receive a user profile from a user terminal via a network interface, the user profile identifying physiological characteristics of the user and an age of the user, and compare the physiological characteristics of the received user profile with the physiological characteristics in each stored profile to identify one of the plurality of subjects having similar physiological characteristics to the user. The devices, methods, and programs analyze the stored expense information that is associated with the identified subject in the memory to determine a trend of the expense of the identified subject, and generate a proposal including a predicted future expense trend for the user based on the determined trend and the user's age. The devices, methods, and programs then transmit the generated proposal to the user terminal via the network interface.

The above and other objects, features, advantages and technical and industrial significance will be better understood by reading the following detailed description of exemplary embodiments, when considered in connection with the accompanying drawings.

### BRIEF DESCRIPTION OF THE DRAWINGS

FIG. 1 is a schematic diagram illustrating an example of generation processing according to an embodiment;

FIG. 2 is a schematic diagram illustrating an exemplary structure of a generation device according to the embodiment;

FIG. 3 is a schematic diagram illustrating an example of a genetic test result table according to the embodiment;

FIG. 4 is a schematic diagram illustrating an example of a settlement information storage unit according to the embodiment;

FIG. 5 is a flowchart illustrating a processing procedure according to the embodiment;

FIG. 6 is a schematic diagram illustrating an example of generation processing according to a modification;

FIG. 7 is a schematic diagram illustrating an exemplary structure of the generation device according to the modification;

FIG. 8 is a schematic diagram illustrating an example of an attribute information table according to another modification; and

FIG. 9 is a hardware structural diagram illustrating an example of a computer that achieves the functions of the generation device.

### DETAILED DESCRIPTION OF EXEMPLARY EMBODIMENTS

The following describes an embodiment of a generation device, a generation method, and a program stored on a computer-readable storage medium in detail with reference to the accompanying drawings. (As used herein the term “storage medium” is not intended to encompass transitory signals.) The following embodiments do not necessarily limit the broader inventive principles for which protection is sought. In the following respective embodiments, the same components are denoted by the same reference numerals and duplicated explanations thereof are omitted.

### 1. Example of Generation Processing

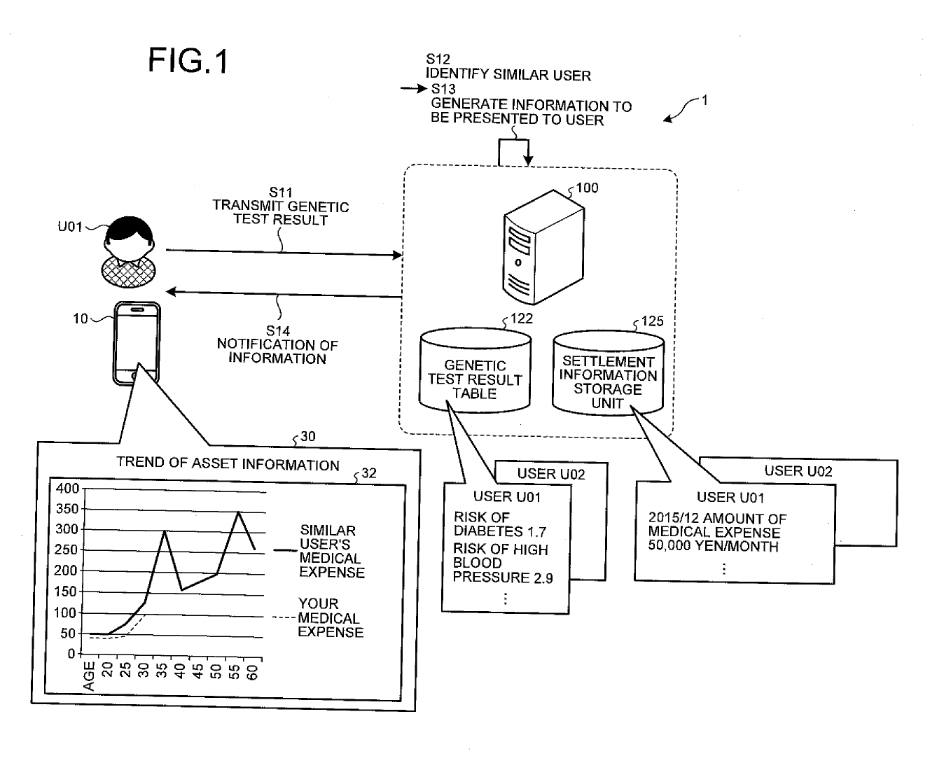

The following describes an example of generation processing according to the embodiment with reference to FIG. 1. FIG. 1 is a schematic diagram illustrating an example of the generation processing according to the embodiment. With reference to FIG. 1, an aspect of the generation processing according to the embodiment is described using a generation system 1 as an example. Specifically, with reference to FIG. 1, an example of the generation processing is described in which a generation device 100, which is a server, included in the generation system 1 identifies a similar user who is a user similar to a user serving as the processing object, and generates information indicating a trend of income or expense of the identified similar user.

As illustrated in FIG. 1, the generation system 1 includes a user terminal 10 and the generation device 100. The devices (the user terminal 10 and the generation device 100) included in the generation system 1 are coupled to each other via a communication network such as the Internet (not illustrated) in a communicable manner. The number of each of the devices included in the generation system 1 is not limited to that illustrated in FIG. 1. For example, the generation system 1 may include a plurality of user terminals 10.

The user terminal 10 is an information processing device used by a user. Specifically, the user terminal 10 is used for transmitting certain information to the generation device 100 or receiving information transmitted from the generation device 100. The user terminal 10 is achieved by a mobile terminal such as a smartphone, a tablet terminal, or a personal digital assistant (PDA), a desktop personal computer (PC), or a notebook PC. In the example illustrated in FIG. 1, the user terminal 10 is a smartphone used by a user U01. In the following explanation, the user terminal 10 is described as the user U01 in some cases. The user U01, thus, can be replaced with the user terminal 10 in the following explanation.

The generation device 100 is a server that provides certain information to the user terminal 10. Specifically, the generation device 100 identifies the similar user who is a user similar to the user U01 under a certain condition on the basis of information received from the user terminal 10. The generation device 100 acquires information about income or expense of the user U01 and the similar user. The generation device 100 generates information that indicates a trend of income or expense of the similar user on the basis of the acquired information. Specifically, the generation device 100 generates comparison information that indicates a comparison of the trend of income or expense between the user U01 and the similar user, and provides the generated comparison information to the user U01. The information about income or expense is a concept widely including information such as an amount of income, an amount of expense, a breakdown of income or expense, information about an income-expense balance, a difference between income and expense, and an amount of savings derived from balance information. The information about income or expense is described as “asset information” in the present specification in some cases.

The generation device 100 may generate a proposal (recommendation) to the user U01 together with the comparison information. For example, the generation device 100 generates a proposal relating to actions that the user U01 could perform in the future. The actions are derived from the comparison of the trend of the asset information about the user U01 and the trend of the asset information about the similar user. For an exemplary proposal, the generation device 100 indicates an amount of expense the user U01 is assumed to need for payments in the future and proposes actions relating to the asset management that the user could perform in the future for covering the assumed amount of expense. The generation device 100 generates the proposal relating to the asset formation of the user U01 on the basis of the trend of the asset information about the similar user, thereby giving certain guidance to the user U01 for preparing future assets. The following describes a flow of the generation processing performed by the generation device 100 with reference to FIG. 1. FIG. 1 illustrates medical expense as an example of the amount of expense the user U01 is assumed to need for payments in the future.

The generation device 100 requests the user U01 to provide information about the user U01 as information used for identifying the user who is similar to the user U01. For example, the generation device 100 requests the information about health of the user U01. The generation device 100 analyzes the information about the health of the user U01' and information about health of another user, determines similarity between the users, and identifies the user who is similar to the user U01.

In the embodiment, the generation device 100 requests, as the information about the health of the user U01, a result of a genetic test the user U01 already underwent. The user U01 transmits the result of the genetic test that the user U01 already underwent to the generation device 100 via the user terminal 10 (step S11).

The result of the genetic test that the user U01 underwent includes types of diseases the user U01 tends to develop and risk values that are values indicating possibilities of developing diseases. In the example illustrated in FIG. 1, the genetic test result of the user U01 includes the risk value of developing diabetes is “1.7” while the risk value of developing “high blood pressure” is “2.9.” In the result of the genetic test that the user U01 underwent, when the risk value corresponding to a type of disease exceeds “2.0,” the possibility (a degree of risk) of developing the disease is determined to be “high.” The determination means that the risk of developing the disease is high, i.e., the possibility of developing the disease is high. When the risk value is between “1.5” and “2.0” in the genetic test result, the possibility of developing the disease is determined to be “medium.” The determination means that the risk of developing the disease is medium, i.e., the possibility of developing the disease is not high enough to be that of the disease determined to be a “high” risk but the possibility of developing the diseases is relatively high.

The generation device 100 receives the genetic test result transmitted from the user terminal 10 and stores the received genetic test result in a genetic test result table 122. The generation device 100 stores, in the genetic test result table 122, not only the genetic test result of the user U01 but also the respective genetic test results transmitted from other users.

When receiving the genetic test result of the user U01, the generation device 100 performs processing that identifies a user who is similar to the user U01 (step S12). Specifically, the generation device 100 compares the types of diseases and the risk values of the respective diseases between the user U01 and other users. For example, the generation device 100 extracts the genetic test result for each of the other users when the types of diseases included in the genetic test result of the user are same as those included in the genetic test result of the user U01, and the percentage of the same disease types is a certain percentage (e.g., 80% or more). The generation device 100 further extracts the genetic test result out of the extracted genetic test results when the degrees of the risks, which are indicated with the risk values of the respective diseases, in the extracted genetic test result are the same as those included in the genetic test result of the user U01, and the percentage of the same degrees of risks is a certain rate. The generation device 100 identifies the users corresponding to the extracted genetic test results as the users who are similar to the user U01.

In the example illustrated in FIG. 1, the generation device 100 identifies a user U02 as the user who is similar to the user U01. The user U02 is a user who underwent the genetic test in which risks of many same diseases as the genetic test that the user U01 underwent are tested, and many items in whose genetic test result match those in the genetic test result of the user U01. For example, the user U02 was diagnosed that a degree of risk of diabetes is “medium” and a degree of risk of high blood pressure is “high” in the genetic test result.

The user U01 provides information about assets of the user U01 to the generation device 100 after transmitting the genetic test result. For example, the user U01 periodically provides, to the generation device 100, information about an amount of monthly expense and a breakdown of the amount of expense. In this case, the user U01 may transmit the information about the assets of the user U01 by itself or provide information (asset information) about income and expense by providing, to the generation device 100, an authority allowing access to data indicating the breakdown of the expense (e.g., a use history of a credit card or logs of interaction with financial institutions). The asset information provided by the user U01 is not limited to the information after the transmission of the genetic test result. The user U01 may provide asset information before the transmission of the genetic test result. The generation device 100 successively stores the asset information provided from the user U01 in a settlement information storage unit 125.

The user U02 periodically provides the asset information about the user U02 to the generation device 100 because the user U02 is also a user serving as the processing object of the generation device 100 besides the user U01. The user U02 is older than the user U01 and has provided asset information to the generation device 100 for a longer period of time than the user U01. The past information at the time when the user U02 was of the same age as the user U01 now, is thus, stored in the settlement information storage unit 125 as the asset information about the user U02.

The generation device 100 generates information to be presented to the user U01 on the basis of the acquired asset information (step S13). Specifically, the generation device 100 generates the comparison information that indicates a comparison of a trend of the asset information about the user U01 and a trend of the asset information about the user U02, who is a similar user. In the example illustrated in FIG. 1, the generation device 100 generates the comparison information using the information about medical expense, which is an example of the asset information, in the expense of the users U01 and U02.

For example, the generation device 100 generates comparison information 30 illustrated in FIG. 1. As illustrated in FIG. 1, the comparison information 30 includes a graph 32 that indicates a comparison of the trend of the asset information between the users U01 and U02. In the graph 32, the age of the user U01 and the amount of medical expense paid at each age are indicated with the broken line titled “your (user U01's) medical expense.” In the graph 32, the age of the user U02 and the amount of medical expense paid at each age are indicated with the broken line titled “similar user's (user U02's) medical expense.” The ordinate axis of the graph 32 represents the amount of medical expense in unit of ten thousand yen. The generation device 100 generates the comparison information 30 that indicates transition in the amounts of medical expense of the user U01 and the user U02 who is similar to the user U01 as the information to be presented to the user U01.

Furthermore, the generation device 100 may generate a proposal to the user U01 as information included in the comparison information 30. For example, the generation device 100 compares a trend of the amount of medical expense of the user U01 from the past to the present and a tendency of the amount of medical expense of the user U02 when the user U02 was of the same age as the user U01. The generation device 100 obtains information that the user U01 is predicted to need to pay a larger amount of medical expense than the current amount a few years later as a result of referring to the tendency of the medical expense of the user U02. For example, the generation device 100 refers to an amount of savings of the user U01 in the asset information acquired from the user U01 and calculates a difference between the amount of savings of the user U01 and the amount of medical expense when the user U02 was of the same age as the user U01 for each of the age of the user U01 in the future. As a result, the generation device 100 obtains information how much amount of money the user U01 should save for another few more years. Using the information, the generation device 100 generates, as a proposal to the user U01, information about actions such as saving money corresponding to the difference calculated from the amount of medical expense paid by the user U02 or take out insurance that covers high risk diseases. The generation device 100 may include the generated proposal in the comparison information 30 as the information displayed together with the graph 32.

The generation device 100 transmits the information such as the generated comparison information 30 to the user terminal 10 to notify the user U01 of the generated information (step S14). The user U01 refers to the comparison information 30 displayed in the user terminal 10, thereby making it possible to obtain information about such as the trend of the amount of medical expense for each age of the user U02 who underwent the genetic test result similar to that of the user U01. When the comparison information 30 includes the proposal generated by the generation device 100, the user U01 can grasp the amount of medical expense predicted to be needed for payments in the future or know actions that should be taken in preparation for the future.

As described above, the generation device 100 according to the embodiment identifies the user U02 who is a user having similarity to the user U01 who is the processing object under a certain condition. The generation device 100 acquires the asset information about the user U01 and the identified user U02. The generation device 100 generates the comparison information that indicates the comparison of the trend of the acquired asset information about the user U01 and the trend of the acquired asset information about user U02.

Specifically, the generation device 100 according to the embodiment identifies the user U02 who is the similar user using the similarity to the genetic test result acquired from the user U01 as the certain condition. The generation device 100 can generate the comparison information 30 that indicates an amount of medical expense assumed to be paid by the user U01 in the future on the basis of the asset information acquired from the users U01 and U02. The generation device 100 notifies the user U01 of the generated information, thereby making it possible to transmit, to the user U01, the trend of the amount of medical expense of the user U02 who has the genetic test result similar to that of the user U01. As a result, the user U01 can obtain certain guidance with regard to expenses containing many uncertain factors in the future such as medical expense. The generation device 100 can provide the user U01 with appropriate information about the future plan.

In the example illustrated in FIG. 1, the user U02 is the user who is similar to the user U01. The generation device 100 may extract not only the user U02 but also a plurality of similar users as the users who are similar to the user U01. The generation device 100 may present the trend of the asset information statistically obtained from the multiple similar users as the object compared with the trend of the asset information about the user U01. The generation device 100, thus, can generate the information that compares the trend of the averaged asset information obtained from a number of samples with the trend of the asset information about the user U01, thereby making it possible to provide comparison information having high reliability to the user U01. In the example illustrated in FIG. 1, the trend of the asset information about the user U01 and the trend of the asset information about the similar user are displayed together in the graph 32 included in the comparison information 30. The display manner is, however, not limited to this example. The generation device 100 may generate the information that indicates only the trend of the asset information about the user U02 instead of the information about the comparison between the users U01 and U02. This information also enables the user U01 to know the trend of the asset information about the user U02 who is a similar user, thereby making it possible for the user U01 to obtain useful information about the future plan of the user U01.

### 2. Structure of Generation Device

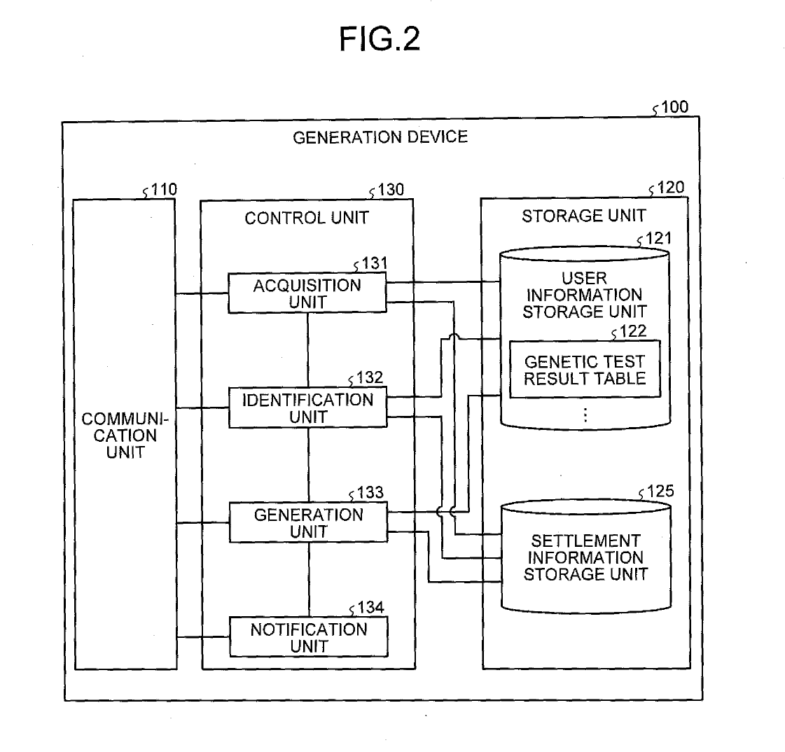

The following describes a structure of the generation device 100 according to the embodiment with reference to FIG. 2. FIG. 2 is a schematic diagram illustrating an exemplary structure of the generation device 100 according to the embodiment. As illustrated in FIG. 2, the generation device 100 includes a communication unit 110, a storage unit 120, and a control unit 130. The generation device 100 may include an input unit (e.g., a keyboard or a mouse) that receives various types of operation from an administrator, for example, who uses the generation device 100, and an output unit (e.g., a liquid crystal display) that outputs various types of information.

The communication unit 110 is achieved by a network interface card (NIC), for example. The communication unit 110 is connected to a communication network in a wired or wireless manner, and exchanges information between itself and the user terminal 10 via the communication network.

The storage unit 120 is achieved by a semiconductor memory element such as a random access memory (RAM) or a flash memory, or a storage device such as a hard disk drive or an optical disc drive. The storage unit 120 according to the embodiment includes a user information storage unit 121 and the settlement information storage unit 125. The following describes the respective storage units one by one.

The user information storage unit 121 stores therein user information that indicates risks relating to the users. In the embodiment, the user information storage unit 121 includes the genetic test result table 122 as one of the data tables that store therein the user information.

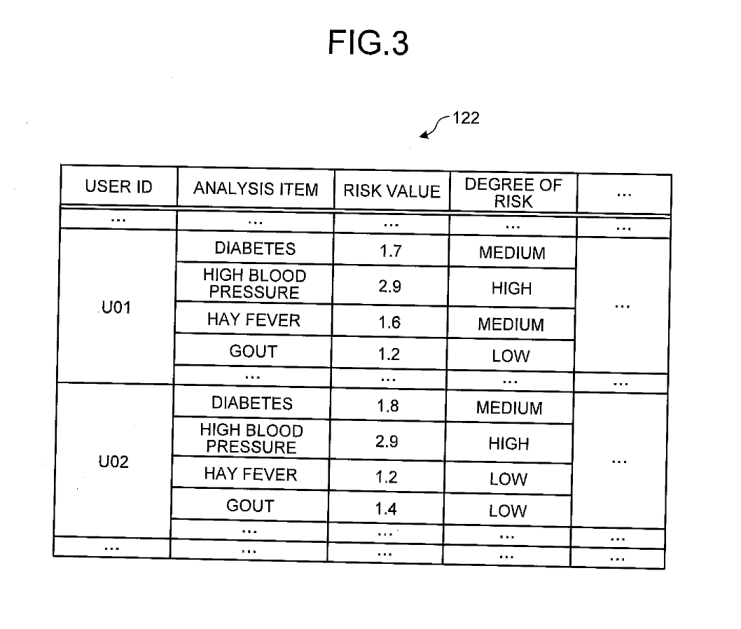

The genetic test result table 122 stores therein the information about the genetic test results. FIG. 3 illustrates an example of the genetic test result table 122 according to the embodiment. As illustrated in FIG. 3, the genetic test result table 122 includes items such as “user ID,” “analysis item,” “risk value,” and “degree of risk.”

The “user ID” indicates identification information to identify the user. In the embodiment, the user ID is in common with the reference sign used in the description. For example, a user having a user ID of “U01” is the “user U01.”

The “analysis item” indicates the item analyzed in the genetic test. The analysis item is represented using the name of a disease, for example. The “risk value” indicates a value obtained by quantifying the risk of developing a disease corresponding to the analysis item.

The “degree of risk” indicates a result obtained by determining the risk of developing a disease on the basis of the risk value. In the embodiment, the analysis item having a risk value lower than “1.5” is determined to be “low” in the degree of risk. This determination indicates that a risk of a user developing the disease corresponding to the analysis item is lower than the disease corresponding to the analysis item having “high” or “medium” in the degree of risk. The analysis item having a risk value higher than “2.0” is determined to be “high” in the degree of risk. This determination indicates that a risk of a user developing the disease corresponding to the analysis item is extremely high. The analysis item having a risk value from “1.5” to “2.0” is determined to be “medium” in the degree of risk. This determination indicates that a risk of a user developing the disease corresponding to the analysis item is higher than the disease corresponding to the analysis item having “low” in degree of risk and lower than the disease corresponding to the analysis item having “high” in degree of risk.

FIG. 3 illustrates the genetic test result that the user U01 identified by the user ID “U01” underwent as an example. The genetic test result shows that the analysis items in the test are “diabetes,” “high blood pressure,” “hay fever,” and “gout,” for example, and the risk values are “1.7,” “2.9,” “1.6,” and “1.2,” respectively, and the degrees of risks are “medium,” “high,” “medium” and “low,” respectively.

As for the degrees of risks illustrated in FIG. 3, the generation device 100 may employ the standard represented by a company conducting the genetic test or the standard determined uniquely by the generation device 100 on the basis of the risk values of the genetic test results. For example, the generation device 100 may acquire the risk values of the genetic test results and statistical information about the number of users who actually developed the diseases, learn a relation therebetween, and uniquely determine the degrees of risks.

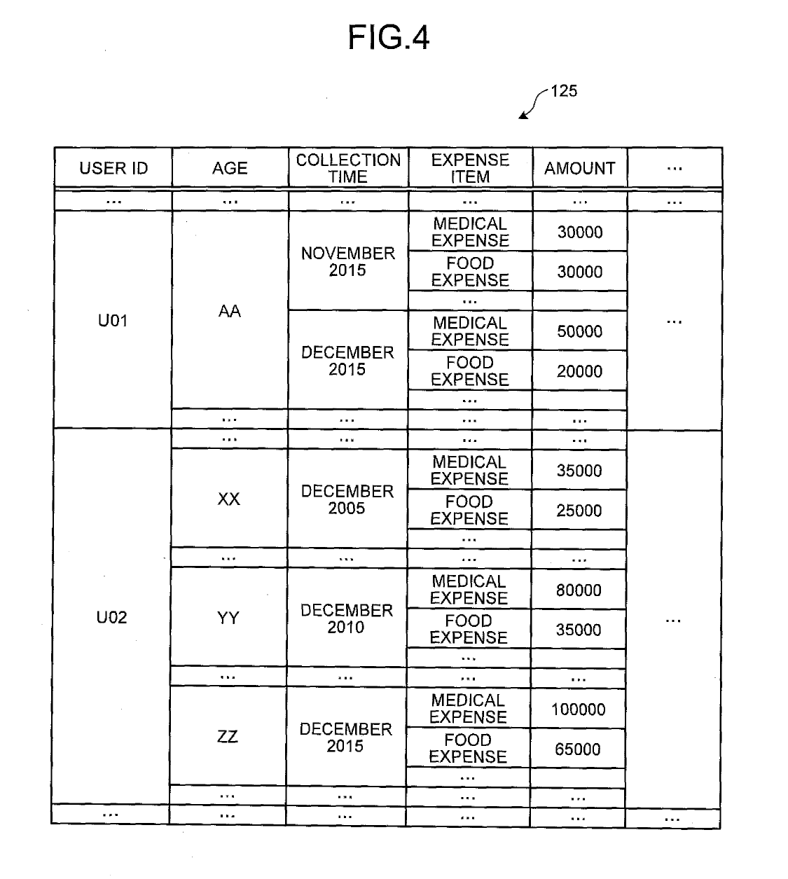

The settlement information storage unit 125 stores therein information (settlement logs) about settlement. FIG. 4 illustrates an example of the settlement information storage unit 125 according to the embodiment. As illustrated in FIG. 4, the settlement information storage unit 125 includes items such as “user ID,” “age,” “collection time,” “expense item,” and “amount.”

The “user ID” corresponds to the same item illustrated in FIG. 3. The “age” indicates the age of the user. FIG. 4 illustrates the ages as “AA,” “XX,” and so on in a conceptual manner. Practically, the age of the user when the settlement log is stored, is stored in the item of “age.”

The “collection time” indicates the time when the user performs the expenditure. The “expense item” indicates the breakdown of the expense. The “amount” indicates the amount of expense for each expense item.

FIG. 4 illustrates information stored in the settlement information storage unit 125 as the settlement log relating to the user U01. The information indicates that the amount of the “medical expense” is “30,000” yen and the amount of the “food expense” is “30,000” yen out of the expense items collected on November 2015 when the user U01 was “AA” years old.

In the example illustrated in FIG. 4, the amount of expense is collected on a monthly basis. The collection manner of the amount of expense to be stored is, however, not limited to the example. For example, an amount of annual expense or a cumulative amount of expenses may be stored for each user in the settlement information storage unit 125.

The control unit 130 is achieved by various programs (corresponding to an example of a generation program) stored in an internal storage device of the generation device 100, the various programs being executed by a central processing unit (CPU) or a micro processing unit (MPU) using a RAM as a working area, for example. The control unit 130 is achieved by an integrated circuit such as an application specific integrated circuit (ASIC) or a field programmable gate array (FPGA).

As illustrated in FIG. 2, the control unit 130 according to the embodiment includes an acquisition unit 131, an identification unit 132, a generation unit 133, and a notification unit 134, and achieves or generates functions and operation of the information processing described below. The internal structure of the control unit 130 is not limited to that illustrated in FIG. 2 and may be any other structure that performs the information processing described below. The connection relation among the respective processing units included in the control unit 130 is not limited to that illustrated in FIG. 2 and may be another connection relation.

The acquisition unit 131 acquires various types of information. The acquisition unit 131 acquires the user information about the user as the information used for identifying the user who has similarity to the user serving as the processing object under a certain condition, for example. The acquisition unit 131 acquires information about the health of the user as an example of the user information. Specifically, the acquisition unit 131 acquires, as the user information, a result of the genetic test the user already underwent.

The acquisition unit 131 acquires, from the user serving as the processing object, the information (asset information) about the income or expense of the user. Specifically, the acquisition unit 131 acquires, as the asset information, the settlement information about such as an amount of expense paid by the user or the breakdown of the expense. The acquisition unit 131 may acquire, as the asset information, an amount of the user's income or an amount of the user's savings, for example.

The acquisition unit 131 may acquire various types of information used for the generation processing, which is described later. For example, when recommending the user to take out insurance covering diseases as the information proposed to the user, the acquisition unit 131 acquires information about the insurance. The acquisition unit 131 may acquire the information by receiving input from the administrator of the generation device 100 or by receiving the information from a company providing the insurance. The acquisition unit 131 may acquire information about a definition used for the processing, such as how the similarity is determined under which condition in the genetic test results of a plurality of users or what kind of proposal is generated.

The acquisition unit 131 stores the acquired information in the respective storage units. For example, the acquisition unit 131 stores the acquired user information in the user information storage unit 121. For another example, the acquisition unit 131 stores the acquired asset information in the settlement information storage unit 125. The acquisition unit 131 does not necessary store the acquired information in the storage unit 120 but may send the acquired information directly to the respective processing units used for the processing.

The identification unit 132 identifies the similar user who is a user having similarity to the user serving as the processing object under a certain condition. For example, the identification unit 132 identifies the similar user by determining similarity in the user information acquired from the user.

When the acquisition unit 131 acquires the genetic test result from the user, the identification unit 132 identifies, as the similar user, a certain user who satisfies a condition of the genetic test result being similar to that of the user. For example, the identification unit 132 determines whether the genetic test result of a certain user has similarity to the genetic test result of the user serving as the processing object using a matching percentage of the items (types of diseases) analyzed in the genetic test result and a matching percentage of the degrees of risks of the analyzed items in the genetic test result of the certain user. Specifically, the identification unit 132 determines the genetic test result having similarity on the basis of that the matching percentage of the items analyzed in the genetic test result is 80% or more and the matching percentage of the degrees of risks of the analyzed items is 80% or more. The identification unit 132, thus, can identify, as the similar users, the users who probably develop the same disease on the basis of the genetic test results. The value of the matching percentage can be changed to any value. For example, the identification unit 132 may perform the identification processing on a plurality of users, perform certain learning processing after the identification processing, and determine an appropriate value for the matching percentage.

The generation unit 133 generates information that indicates a trend of the income or expense of the similar user on the basis of the information acquired by the acquisition unit 131. The generation unit 133 generates the comparison information that indicates a comparison of the trend of income or expense between the user and the similar user, for example. When the acquisition unit 131 acquires, as the information about income or expense, information about the amount of expense with a classification in which the breakdown of the expense is classified into certain items, the generation unit 133 generates the comparison information about the trend of the amount of expense for each certain item. Practically, the generation unit 133 generates the comparison information 30 that indicates the comparison of the amount of medical expense between the user and the similar user as illustrated in FIG. 1.

When the acquisition unit 131 acquires the information (asset information) about the income or expense of a plurality of similar users, the generation unit 133 may generate the comparison information about the trend of the asset information about the user and the trend of the asset information statistically obtained from the multiple similar users.

The generation unit 133 may generate a proposal to the user together with the comparison information notified to the user. For example, the generation unit 133 calculates an assumed amount of medical expense of the user in the future, and generates, as the proposal, the information about actions to secure money for the medical expense in the future. Specifically, the generation unit 133 generates the proposal that indicates actions (e.g., save money or make an investment) relating to the asset formation performed by the user and insurance the user should take out, for example. The generation unit 133 may generate a proposal that indicates a specific amount such as a proposal of how much amount of expense the user should reduce or a proposal of a slight increase in an amount of expense being acceptable.

When generating a proposal to the user, the generation unit 133 may use definition information that indicates contents of proposed actions. The definition information is generated by the administrator of the generation device 100 and held in the generation device 100, for example. The definition information includes a definition used for the processing such as a definition in which an action proposed to the user is “to save money” when a certain difference is present between an amount of expense of the user serving as the processing object and an amount of the expense of the similar user when the similar user was of the same age as the user. The generation device 100 can generate an appropriate proposal to the user in accordance with the definition information. The definition information may be appropriately amended or changed by the administrator, for example, of the generation device 100 or by the generation device 100. Information about types of insurance (insurance covering diseases) proposed to the user or an appropriate investment destination based on an assumed amount of medical expense may be stored as the definition information.

The notification unit 134 makes notification of various types of information. For example, the notification unit 134 transmits the information generated by the generation unit 133 to the user terminal 10 to notify the user of the trend of the asset information about the similar user. Specifically, the notification unit 134 transmits the comparison information generated by the generation unit 133 to the user terminal 10 to notify the user of the information that indicates the comparison of the asset information between the user and the similar user.

The notification unit 134 notifies the user of the information that indicates the comparison of the trend of the asset information between the users U01 and U02 as represented by the graph 32 in the comparison information 30 illustrated in FIG. 1, for example. When the information generated by the generation unit 133 includes a proposal to the user, the notification unit 134 notifies the user of the generated proposal. For example, the notification unit 134 notifies the user of a proposal that encourages the user to save more money on the basis of the comparison of current asset information about the user and the asset information about the similar user when the similar user was of the same age as the user. The user can obtain guidance for actions that the user could perform by referring to the information via the user terminal 10.

### 3. Processing Procedure

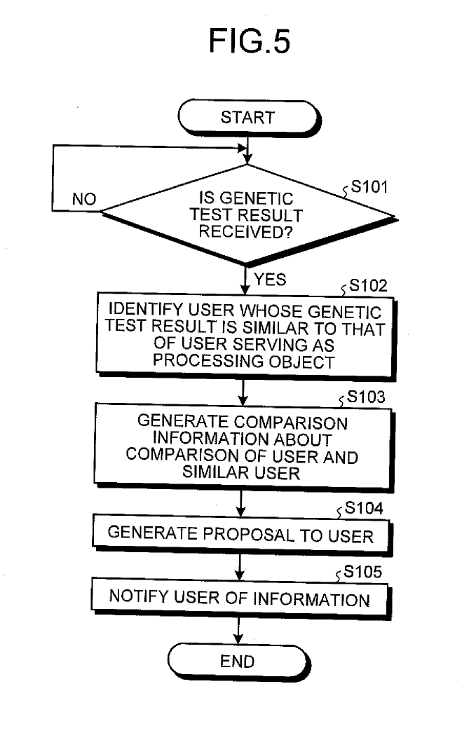

The following describes a procedure of the processing performed by the generation device 100 according to the embodiment with reference to FIG. 5. FIG. 5 is a flowchart illustrating a processing procedure performed by the generation device 100 according to the embodiment.

As illustrated in FIG. 5, the acquisition unit 131 of the generation device 100 determines whether a genetic test result is received from a user as the user information (step S101). If no genetic test result is received (No at step S101), the acquisition unit 131 stands-by until the reception of the genetic test result.

If the acquisition unit 131 receives the genetic test result (Yes at S101), the identification unit 132 identifies a user whose genetic test result is similar to that of the user (step S102).

The generation unit 133 generates the comparison information about the comparison of the user serving as the processing object and the user identified by the identification unit 132 (step S103). The generation unit 133 generates a proposal to the user (step S104). The notification unit 134 transmits the information generated by the generation unit 133 to the user, thereby notifying the user of the information (step S105).

The generation unit 133 does not have to generate a proposal to the user in case of notifying the user only of the comparison information about the comparison of the trend of the asset information. In this case, the processing at step S104 is skipped.

### 4. Modifications

The generation device 100 according to the embodiment may be implemented in various forms besides the embodiment. The following describes other embodiments of the generation device 100.

### 4-1. Attribute Information

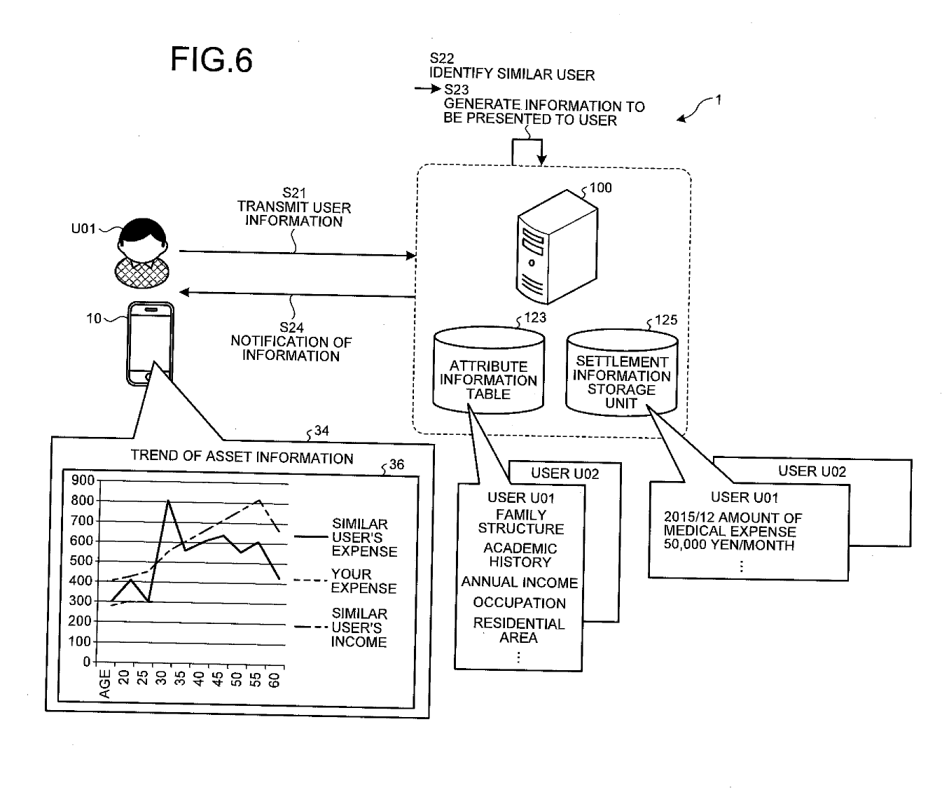

In the embodiment described above, the generation device 100 generates the comparison information on the basis of the genetic test result acquired from the user. The generation device 100 may further acquire detailed information about the user as the user information to generate the comparison information. The following describes the generation processing with reference to FIG. 6.

FIG. 6 is a schematic diagram illustrating an example of the generation processing according to a modification. In the example illustrated in FIG. 6, the user U01 who uses the user terminal 10 further provides detailed information about the user U01 to the generation device 100 together with the genetic test result. The generation device 100 generates the comparison information on the basis of the information provided from the user U01.

As illustrated in FIG. 6, the user terminal 10 transmits the user information serving as the information about the user U01 (step S21). The user information transmitted from the use terminal 10 is attribute information that indicates attributes of the user U01, for example. The attribute information about the user U01 is the information that indicates a family structure, an academic history, an annual income, an occupation, or a residential area, for example.

The generation device 100 acquires the attribute information about the user U01 transmitted from the user terminal 10. The generation device 100 stores the acquired attribute information in an attribute information table 123. The generation device 100 specifies a similar user on the basis of the attribute information about the user U01 (step S22).

For example, the generation device 100 extracts other users having attribute information including the same items as the attribute information about the user U01. Examples of the items include the family structure, the academic history, the annual income, the occupation, and the residential area. The generation device 100 identifies a user as the similar user when the certain number or more of items in the attribute information of the user are the same as those of the attribute information about the user U01, for example. The generation device 100 may further identify a user who has the attribute information more similar to that of the user U01 out of the extracted users who are similar to the user U01 and are extracted on the basis of the genetic test results illustrated in FIG. 1.

The generation device 100 generates, as the information to be presented to the user U01, comparison information 34 about the comparison of the user U01 and the similar user identified at step S22 (step S23).

In FIG. 6, the comparison information 34 generated by the generation device 100 includes a graph 36. As illustrated in FIG. 6, the graph 36 includes an amount of income of the similar user in addition to the amount of your (user U01's) expense and an amount of expense of the similar user. In this way, the generation device 100 acquires the attribute information from the user serving as the processing object, thereby generating the comparison information 34 including more information than that of the comparison information 30 illustrated in FIG. 1.

The generation device 100 transmits the information such as the generated comparison information 34 to the user terminal 10 to notify the user U01 of the generated information (step S24). As a result, the user U01 can browse the comparison information including not only the amount of expense but also the comparison of the attribute information between the user U01 and the other user.

When the generation device 100 according to the modification acquires the information about the attributes of a user, and the information about the acquired attributes of the user and the information about the attributes of another user have similarity, the generation device 100 may perform processing in such a mariner that the other user is identified as the similar user.

The generation device 100 acquires, as the user information, not only the genetic test result but also the attribute information about the user U01, thereby making it possible to identify the user who is similar to the user U01 on the basis of the acquired information. For example, a difference occurs, in some cases, in the trend of an amount of income or expense of a user who is similar to the user U01 in the genetic test result depending on whether the residential area of the user who is similar to the user U01 in the genetic test result is a city or a countryside. The generation device 100 according to the modification identifies the user using further the attribute information about the user U01, thereby making it possible to accurately identify the user who is similar to the user U01. As a result, the user U01 can obtain the comparison information about the comparison with an appropriate similar user as a further reference to the asset formation of the user U01 in the future.

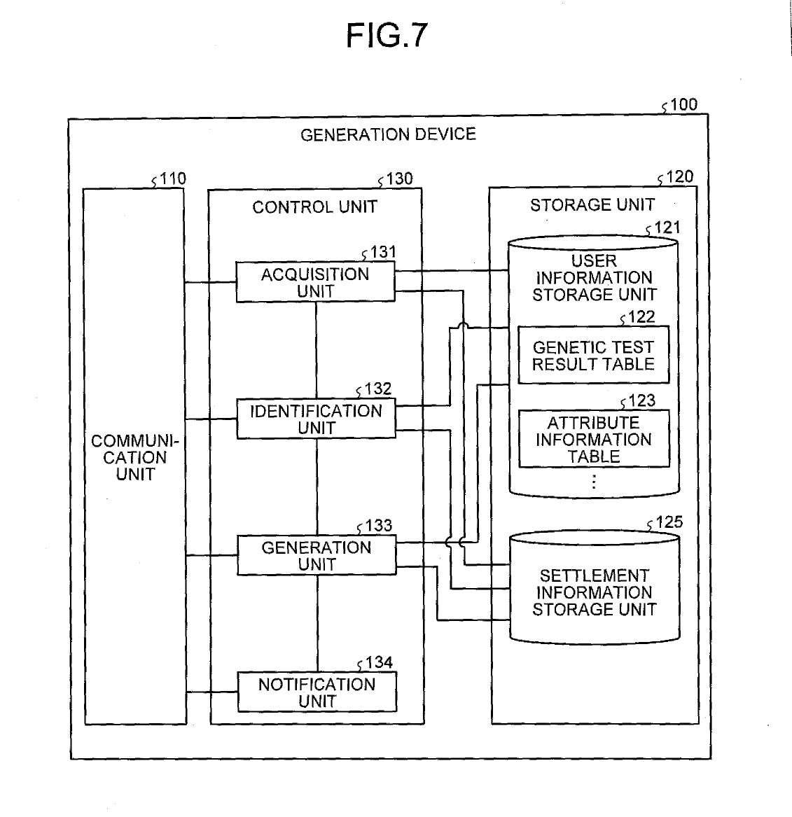

The following describes a structure of the generation device 100 according to the modification. FIG. 7 is a schematic diagram illustrating an exemplary structure of the generation device 100 according to the modification. As illustrated in FIG. 7, the generation device 100 according to the modification further includes the attribute information table 123 in addition to the structure of the generation device 100 illustrated in FIG. 1.

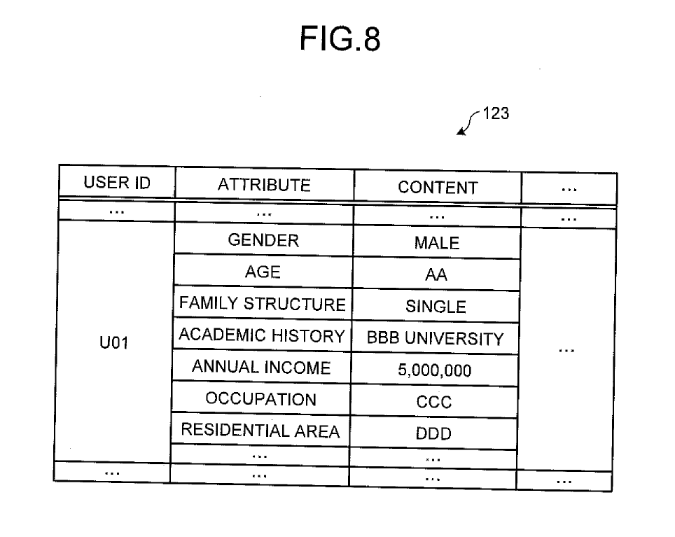

The attribute information table 123 is one of the data tables included in the user information storage unit 121. The attribute information table 123 stores therein the information about the attribute information about the user. FIG. 8 illustrates an example of the attribute information table 123 according to the modification. As illustrated in FIG. 8, the attribute information table 123 includes items such as “user ID,” “attribute,” and “content.”

The “user ID” corresponds to the same item illustrated in FIG. 3. The “attribute” indicates the type of attribute information about the user. The “content” indicates the content of each type of the attribute information.

FIG. 8 illustrates the attribute information about the user U01 as an example of the information stored in the attribute information table 123. In the example, types of attribute information such as “gender,” “age,” “family structure,” “academic history,” “annual income,” “occupation,” and “residential area” are stored. The contents of the respective types of attribute information about the user U01 indicate that the gender is “male,” the age is “AA,” the family structure is “single,” the academic history is “graduate of BBB university,” the annual income is “5,000,000” yen, the occupation is “CCC,” and the residential area is “DDD.”

The generation device 100 according to the modification can determine similarity between users or generate the comparison information about the attribute information using the attribute information about the respective users stored in the attribute information table 123.

### 4-2. Condition Setting

In the embodiment described above, the generation device 100 identifies the similar user of the user serving as the processing object on the basis of conditions such as similarity to the genetic test result and similarity to the attribute information. The generation device 100 may preliminarily receive a condition from the user serving as the processing object and identify the similar user serving as the comparison object.

For example, the user transmits, to the generation device 100, a condition of a user (hereinafter described as a “designated user”) who is the target person, i.e., a person the user wants to compare with. Specifically, the user sets a similar user who has an amount of savings more than “10,000,000” yen at the age of “50 years old” among the similar users as a condition of the designated user who will be the comparison object of the user, and transmits the condition to the generation device 100. The generation device 100 receives the condition from the user, and extracts the designated user who matches the condition out of the similar users. The generation device 100 generates the comparison information about comparison of the asset information between the designated user and the user serving as the processing object.

In this case, the user can know the trend of the asset information about the designated user who has an amount of savings more than 10,000,000 yen at 50 years old as the generated information. The user, thus, can check how the designated user, who achieves the target set by the user, formed the asset that the user aims to build up in addition to the similarity with regard to the genetic test result. As a result, the user can obtain the information that is more useful for the user's future plan.

### 4-3. User Information

In the embodiment described above, the generation device 100 acquires, as the user information, the genetic test result and information about the attribute information. The user information acquired by the generation device 100 is, however, not limited to the examples. For example, the generation device 100 may use various types of information as the user information as long as the various types of information include the information capable of identifying a similar user. For example, the generation device 100 may use a result of a medical examination that the user U01 underwent as the user information instead of the genetic test result.

### 4-4. Display of Risk

In the embodiment described above, a risk of the user developing a certain disease is indicated by the risk value or the degree of risk evaluated in three stages such as “high,” “medium,” and “low.” The generation device 100, however, does not have to use such displays when determining or evaluating the risk. For example, the generation device 100 may indicate whether the possibility of the user U01 developing a certain disease is higher or lower than those of other general users with a percentage or rate.

### 5. Others

In the processes described in the embodiment, all or a part of the processes described to be automatically performed can also be manually performed. Alternatively, all or a part of the processes described to be manually performed can also be automatically performed by known methods. In addition, the processing procedures, the specific names, and information including various types of data and parameters described in the above description and drawings can be changed as required unless otherwise specified.

Furthermore, the components of the devices illustrated in the drawings are functionally conceptual ones, and are not always required to be physically configured as illustrated in the drawings. That is, specific forms of distributions and integrations of the devices are not limited to those illustrated in the drawings. All or a part of the devices can be configured to be functionally or physically distributed or integrated in arbitrary units in accordance with various loads, the usage states, and the like.

For example, the user information storage unit 121 and the settlement information storage unit 125, which are illustrated in FIG. 2, do not have to be included in the generation device 100 but may be included in an external storage server. In this case, the generation device 100 accesses the storage server to acquire the user information and the settlement information.

The generation device 100 may be separated into a front-end server side that primarily executes processing relating to external devices such as receiving the user information from the user terminal 10, and a back-end server side that executes internal processing such as generating the comparison information, for example.

### 6. Hardware Structure

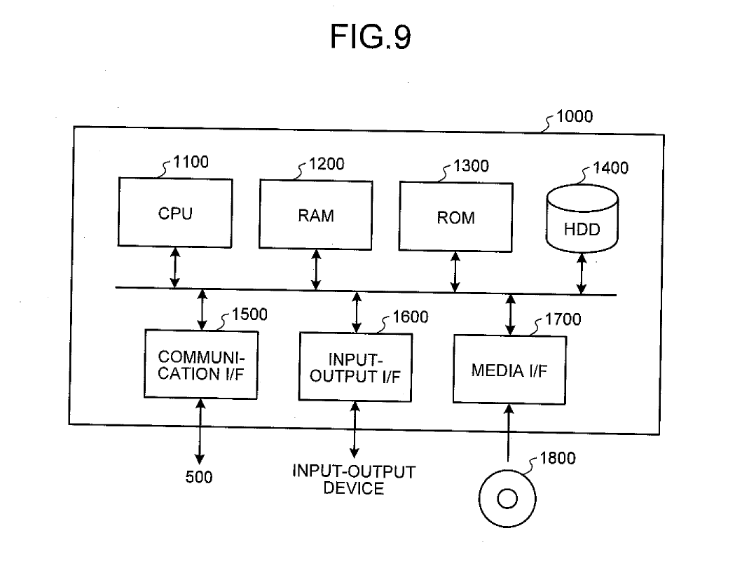

The generation device 100 according to the embodiment is achieved by a computer 1000 having the structure illustrated in FIG. 9, for example. FIG. 9 is a hardware structural diagram illustrating an example of the computer 1000 that achieves the functions of the generation device 100. The computer 1000 includes a CPU 1100, a RAM 1200, a read only memory (ROM) 1300, a hard disk drive (HDD) 1400, a communication interface (I/F) 1500, an input-output interface (I/F) 1600, and a media interface (I/F) 1700.

The CPU 1100 operates on the basis of a program stored in the ROM 1300 or the HDD 1400, and controls the respective components. The ROM 1300 stores therein a boot program executed by the CPU 1100 when the computer 1000 is booted, and programs dependent on the hardware of the computer 1000, for example.

The HDD 1400 stores therein programs executed by the CPU 1100 and data used by the programs, for example. The communication I/F 1500 receives data from other apparatuses via a communication network 500 and sends the data to the CPU 1100. The communication I/F 1500 transmits data generated by the CPU 1100 to other apparatuses via the communication network 500.

The CPU 1100 controls an output device such as a display or a printer and an input device such as a keyboard or a mouse via the input-output I/F 1600. The CPU 1100 acquires data from the input device via the input-output I/F 1600. The CPU 1100 outputs generated data to the output device via the input-output I/F 1600.

The media I/F 1700 reads a program or data stored in a recording medium 1800 and provides it to the CPU 1100 via the RAM 1200. The CPU 1100 loads the program in the RAM 1200 from the recording medium 1800 via the media I/F 1700 and executes the loaded program. The recording medium 1800 is an optical recording medium such as a digital versatile disc (DVD) or a phase change rewritable disc (PD), a magneto-optical recording medium such as a magneto-optical disc (MO), a tape medium, a magnetic recording medium, or a semiconductor memory.

For example, when the computer 1000 functions as the generation device 100, the CPU 1100 of the computer 1000 executes the generation program loaded in the RAM 1200 to achieve the functions of the control unit 130. The HDD 1400 stores therein the various types of data in the storage unit 120. The CPU 1100 of the computer 1000, which reads the programs from the recording medium 1800 and executes them, may acquire the programs from another device via the communication network 500.

### 7. Advantages

As described above, the generation device 100 according to the embodiment includes the identification unit 132, the acquisition unit 131, and the generation unit 133. The identification unit 132 identifies the similar user who is a user having similarity to the user serving as the processing object under a certain condition. The acquisition unit 131 acquires the information about income or expense of the similar user identified by the identification unit 132. The generation unit 133 generates the information that indicates a trend of the income or expense of the similar user on the basis of the information acquired by the acquisition unit 131.

The generation device 100 according to the embodiment identifies the similar user who is similar to the user and generates the information that indicates a trend of income or expense of the identified similar user. The generation device 100, thus, can give certain guidance to the user for concerns including many items the user hardly foresees such as the asset formation in the future. As a result, the generation device 100 can provide the user with appropriate information about the user's future plan.

The acquisition unit 131 acquires the information about income or expense of the user. The generation unit 133 generates the comparison information that indicates a comparison of the trend of income or expense between the user and the similar user.

The generation device 100 according to the embodiment generates the information about the comparison of the similar user and the user when generating the information about the income or expense of the similar user. The user, thus, receives the information that allows the user to check at a glance the comparison of the settlement information and the trend of the assets between the user and the similar user. As a result, the user can more clearly obtain the information about the asset formation. The generation device 100 can provide the user with appropriate information about the user's future plan.

The acquisition unit 131 acquires the information about the health of the user. When the information about the health of the user acquired by the acquisition unit 131 and the information about the health of another user have similarity, as a certain condition, the identification unit 132 identifies the other user as the similar user.

The generation device 100 according to the embodiment uses the information about the health of the users, when determining similarity between the users. The generation device 100, thus, can provide the user with appropriate information about the trend of medical expense, which contains many uncertain factors, out of the expense of the user in the future.

The acquisition unit 131 acquires the genetic test result of the user. When the genetic test result of the user acquired by the acquisition unit 131 and the genetic test result of another user have similarity, as a certain condition, the identification unit 132 identifies the other user as the similar user.

The generation device 100 according to the embodiment acquires the genetic test result as a specific example of the user information. The genetic test highly accurately detects characteristics relating to the health of the user, such as a constitution that easily develops diseases. The generation device 100 uses the genetic test result, thereby making it possible to determine similarity with extremely high accuracy. The generation device 100, thus, can generate the comparison information about the comparison of the user and the similar user who is assumed to tend to be more similar to the user, thereby making it possible to more appropriately provide the user with guidance for the user's asset formation in the future.

The acquisition unit 131 acquires the genetic test result in which the degrees of the risks are indicated for the respective types of diseases. The identification unit 132 identifies another user as the similar user on the basis of the matching percentages of the types of diseases and the degrees of the risks corresponding to the types of diseases that are included in the genetic test results of the user and the other user. In other words, the identification unit 132 determines the similarity between the genetic test result of the user and the genetic test result of the other user on the basis of the matching percentages of the types of diseases and the degrees of the risks corresponding to the types of diseases that are included in the genetic test results.

The generation device 100 according to the embodiment determines the similar user on the basis of the types of diseases the analysis results of which are indicated and the degrees of the risks corresponding to the types of diseases in the genetic test result. As a result, the generation device 100 can accurately identify a similar user.

The acquisition unit 131 acquires, as the information about income or expense, the information about the amounts of expense of the user and the similar user. The generation unit 133 generates the comparison information that indicates a comparison of the trend of the amount of expense between the user and the similar user.

The generation device 100 according to the embodiment can generate, on the basis of the actual result of the similar user, the information capable of serving as certain guidance for the expense in the future, which is uncertain information for the user. As a result, the generation device 100 can provide the user with appropriate information about the user's future plan.

The acquisition unit 131 acquires the information about the amount of expense the breakdown of which is classified into certain items. The generation unit 133 generates the comparison information that indicates a comparison of the trend of the amount of expense for each certain item between the user and the similar user in the information about the amounts of expense of the user and the similar user.

As a result, the generation device 100 can provide the user with the more detailed information about the expense indicated for respective expense items. The generation device 100, thus, can provide the user with useful information about the user's future plan.

The acquisition unit 131 acquires the information about income or expense of a plurality of similar users. The generation unit 133 generates the comparison information that indicates a comparison of the trend of income or expense of the user and the trend of income or expense statistically obtained from the multiple similar users.

The generation device 100 according to the embodiment generates the comparison information about the trend of income or expense from not only data of a specific person but also data statistically obtained from a plurality of samples. As a result, the generation device 100 can provide the user with appropriate comparison information suppressing inclinations.

The generation unit 133 generates, as the information included in the comparison information, a proposal for the user's actions on the basis of the comparison of the trend of income or expense between the user and the similar user.

The generation device 100 according to the embodiment can generate a proposal to the user in addition to the comparison information. As a result, the generation device 100 can provide the user with appropriate information about the user's asset formation.

The generation unit 133 generates, as the proposal for the user's actions, the proposal for the asset management performed by the user or the proposal for insurance the user should take out.

The generation device 100 according to the embodiment can provide the user with information useful for the user's future such as a proposal that can be used as a factor to determine whether the user should save money or make an investment, and a proposal for an insurance according to the types of diseases.

The acquisition unit 131 acquires the information about the attributes of the user. When the information about the attributes of the user acquired by the acquisition unit 131 and the information about the attributes of another user have similarity, as a certain condition, the identification unit 132 identifies the other user as the similar user.

The generation device 100 according to the embodiment may identify the similar user on the basis of not only the information about the health such as the genetic test result but also the information about the attributes of the user. As a result, the generation device 100 can increase the accuracy in identifying the similar user. As a result, the generation device 100 can provide the user with the comparison information about the comparison with the similar user assumed to be more similar to the user.

The identification unit 132 identifies the designated user who is a user matching a condition designated by the user out of similar users. The acquisition unit 131 acquires the information about income or expense of the designated user identified by the identification unit 132 and the information about income or expense of the user. The generation unit 133 generates the comparison information that indicates a comparison of the trend of the income or expense between the user and the designated user on the basis of the information acquired by the acquisition unit 131.

The generation device 100 according to the embodiment may receive any condition from the user, and identify, as the designated user, a user who matches the condition. The generation device 100, thus, can generate the comparison information that allows the user to refer to the information about income or expense of the other user who achieves the condition that the user aims for, for example. As a result, the generation device 100 enables the user to obtain the information more useful for the future plan.

The embodiments are described in detail with reference to the accompanying drawings as a way of example. The broad inventive principles can be implemented in other embodiments changed or modified on the basis of the knowledge of the persons skilled in the art besides the embodiments described herein.

The generation device 100 may be achieved by a plurality of server computers. The structure thereof can be changed flexibly. For example, some functions are achieved by calling external platforms using an application programming interface (API) or a network computing system.

The above-described embodiments have an advantage of providing the user with appropriate information about the user's future plan.

Although the inventive principles have been presented in the context of specific exemplary embodiments for a complete and clear disclosure, the appended claims need not be limited by those examples and should be construed as embodying all modifications and alternative constructions that may occur to one skilled in the art that fairly fall within the basic teaching herein set forth.

What is claimed is:

1. A network device that identifies similar, users based on physiological characteristics to predict income and expense trends, the device comprising:
a network interface;
a memory that stores expense information for each of a plurality of subjects, the expense information for each of the plurality of subjects being associated with a stored subject profile that identifies physiological characteristics of a corresponding one of the subjects; and
a processor operatively connected to the network interface and the memory, the processor programmed to:
receive a user profile from a user terminal via the network interface, the user profile identifying physiological characteristics of the user and an age of the user;
compare the physiological characteristics of the received user profile with the physiological characteristics in each stored profile to identify one of the plurality of subjects having similar physiological characteristics to the user;
analyze the stored expense information that is associated with the identified subject in the memory to determine a trend of the expense of the identified subject;
generate a proposal including a predicted future expense trend for the user based on the determined trend and the user's age; and
transmit the generated proposal to the user terminal via the network interface.

2. The network device according to claim 1, wherein:
the physiological characteristics of the received user profile include a likelihood of the user having a particular medical condition; and
the physiological characteristics in each stored profile to identify the likelihood of the corresponding subject having one or more medical conditions.

3. The network device according to claim 1, wherein the received user profile includes information about a particular health condition of the user.

4. The network device according to claim 1, wherein:
the received user profile includes a genetic test result of the user; and
each stored subject profile includes a genetic test result of the associated subject.

5. The network device according to claim 4, wherein:
the genetic test result of the user indicates degrees of risks for respective types of diseases; and
each stored subject profile includes degrees of risks for respective types of diseases.

6. The network device according to claim 1, wherein:
the processor is programmed to receive expense information about the user from the user terminal via the network interface, the expense information including a user expense trend; and
the generated proposal includes a comparison of the received user expense trend and the determined trend of the expense of the identified subject.

7. The network device according to claim 6, wherein:
the received expense information is categorized into expenses for certain items; and
the generated proposal includes a comparison of the received user expense for each certain item and a respective determined trend of the expense of the identified subject for each certain item.

8. The network device according to claim 6, wherein:
the processor is programmed to receive income information about the user from user terminal via the network interface; and
the generated proposal includes an effect of the determined trend of the expense of the identified subject on the user's income.

9. The network device according to claim 1, wherein the processor is programmed to:
compare the physiological characteristics of the received user profile with the physiological characteristics in each stored profile to identify a subset of the subjects having similar physiological characteristics to the user; and
statistically analyze the stored expense information that is associated with each of the identified subjects in the memory to determine a trend of the expense of the identified subjects.

10. The network device according to claim 1, wherein the generated proposal includes a recommended action of the user.

11. The network device according to claim 10, wherein the recommended action relates to asset management or medical insurance.

12. The network device according to claim 1, wherein:
the received user profile includes demographic information about the user including at least one of: a family structure of the user, an academic history of the user, an annual income of the user, an occupation of the user, and a residential area of the user;
each stored subject profile includes demographic information about the corresponding subject including at least one of: a family structure of the subject, an academic history of the subject, an annual income of the subject, an occupation of the subject, and a residential area of the subject; and
the processor is programmed to identify the one of the plurality of subjects having similar physiological characteristics to the user by:
comparing the demographic information of the received user profile with the demographic information of each stored subject profile; and
selecting one of the plurality of subjects having similar physiological characteristics to the user and similar demographic information as the user.

13. The network device according to claim 1, wherein:
the received user profile includes a specified medical condition;
each stored subject profile includes a medical condition of the associated subject; and
the processor is programmed to compare the specified medical condition with the medical condition in each stored profile to identify the subject having the similar physiological characteristics to the user.

14. A network method that that identifies similar users based on physiological characteristics to predict income and expense trends, the method comprising:
accessing a memory that stores expense information for each of a plurality of subjects, the expense information for each of the plurality of subjects being associated with a stored subject profile that identifies physiological characteristics of a corresponding one of the subjects;
receiving a user profile from a user terminal via a network interface, the user profile identifying physiological characteristics of the user and an age of the user;
comparing the physiological characteristics of the received user profile with the physiological characteristics in each stored profile to identify one of the plurality of subjects having similar physiological characteristics to the user;
analyzing the stored expense information that is associated with the identified subject in the memory to determine a trend of the expense of the identified subject;
generating a proposal including a predicted future expense trend for the user based on the determined trend and the user's age; and
transmitting the generated proposal to the user terminal via the network interface.

15. A computer-readable storage medium having stored therein a computer program that identifies similar users based on physiological characteristics to predict income and expense trends, the program causing a computer to execute a process comprising:
accessing a memory that stores expense information for each of a plurality of subjects, the expense information for each of the plurality of subjects being associated with a stored subject profile that identifies physiological characteristics of a corresponding one of the subjects;
receiving a user profile from a user terminal via a network interface, the user profile identifying physiological characteristics of the user and an age of the user;
comparing the physiological characteristics of the received user profile with the physiological characteristics in each stored profile to identify one of the plurality of subjects having similar physiological characteristics to the user;
analyzing the stored expense information that is associated with the identified subject in the memory to determine a trend of the expense of the identified subject;
generating a proposal including a predicted future expense trend for the user based on the determined trend and the user's age; and
transmitting the generated proposal to the user terminal via the network interface.
